(19) United States
(12) Patent Application Publication
(10) Pub. No.: US 2015/0316293 A1
(43) Pub. Date: Nov. 5, 2015

(54) BEARING ASSEMBLY AND PARABOLIC-TROUGH SOLAR POWER PLANT HAVING SUCH A BEARING ASSEMBLY

(71) Applicant: AKTIEBOLAGET SKF, Göteborg (SE)

(72) Inventors: Markus BEHN, Diekholzen (DE); Heinz BREUNIG, Aschaffenburg (DE); Hubert HERBST, Gädheim (DE); Henning KERN, Schweinfurt (DE); Hnas-Jürgen LIESEGANG, Schortens (DE); Mathias NOETH, Wasserlosen (DE); Christina PFEUFFER, Eußenheim (DE)

(21) Appl. No.: 14/438,045

(22) PCT Filed: Oct. 24, 2013
(86) PCT No.: PCT/EP2013/072230

§ 371 Date: Apr. 23, 2015

(30) Foreign Application Priority Data
Oct. 25, 2012 (DE) 10 2012 219 482.7

(51) Int. Cl. F24J 2/54; F16C 13/04

(52) U.S. Cl. CPC F24J 2/5413; F16C 13/04; F24J 2002/5482

(57) ABSTRACT

A parabolic-trough solar power plant includes at least one solar panel that has a shaft part supported by at least one bearing assembly configured to pivot the solar panel through a pivot angle about the longitudinal axis. The bearing assembly includes a support element with two support sections and a space therebetween, a chain element supported by the support sections, and a plurality of roller elements supported in the chain element along its longitudinal extension for rotation about an axis of rotation parallel to the longitudinal axis. Ends of the chain element are attached to the support sections by bearings that permit pivoting of the chain element relative to the support sections about a compensation axis horizontal, and in projection, perpendicular to the longitudinal axis of the shaft part. The roller elements are disposed at hinge points between pairs of the links in the chain.

The invention relates to a bearing assembly for a component that includes a shaft part having a longitudinal axis, wherein the bearing assembly is configured to pivot the component through a pivot angle range, in particular of less than 225°, about the longitudinal axis. Furthermore, the invention relates to a parabolic-trough solar power plant comprising at least one solar panel.

Parabolic-trough systems are one design of solar power plants, wherein solar panels are used that concentrate solar energy in a center due to their parabolic mirror surface in order to thereby heat, for example, a working medium (e.g., water). The solar panel is tracked to the position of the sun so that the system works efficiently. For this purpose the solar panel is pivotably supported about a pivot axis that corresponds to the above-mentioned longitudinal axis. Systems of this type generally include a plurality of solar panels that are connected in series, i.e., a quantity of solar panels connect in the direction of the longitudinal axis, which are connected (screwed) to one another. The entire assembly is then pivoted using a suitable drive.

Here it is problematic that due to the resulting relatively large extension of the screwed-together panels in the direction of the longitudinal axis, not-insignificant thermal expansions result with heating of the system. Accordingly at least some of the bearing positions must be configured as non-locating bearings. Up to now the usual solutions are not satisfactory, in particular also from cost perspectives.

The object of the invention is to further develop a bearing assembly of the above-described type such that thermally induced expansions in the assembly of a quantity of components (i.e., in particular, of solar panels) can be compensated in a simple and efficient manner. Here the bearing assembly should be cost-effectively manufacturable, since a very large quantity of bearing positions is often required for power plants of this type. Furthermore, a solar power plant, in particular a parabolic-trough solar power plant, should be proposed that is equipped with such bearing assemblies.

The solution of this object by the invention is characterized in that the bearing assembly comprises:
a support element that includes two vertically extending support sections, wherein a receiving space for receiving the shaft part is formed between the two support sections,
a chain element that is supported with its two ends in the upper end region of the bearing section,
a quantity of roller elements that are supported in the chain element along its longitudinal extension, wherein the roller elements are supported in the chain element about an axis of rotation parallel to the longitudinal axis, and wherein the roller elements are configured to support a circumferential section of a shaft section of the shaft part,
wherein the upper ends of the chain element are each attached to the support section by a bearing, and the bearing makes possible a pivoting of the chain element relative to the support section about a compensation axis, wherein the compensation axis is disposed horizontal and in projection is perpendicular to the longitudinal axis of the shaft part.

The chain element preferably includes a quantity of chain links, wherein the roller elements are disposed at the hinge point between two chain links.

The roller elements preferably have a centrally disposed central section, which is configured for making contact with the shaft section of the shaft part; this central section preferably has a cylindrical radial outer contour. Here the centrally disposed central section is preferably delimited axially on both sides by two enlarged-in-diameter flange sections.

The bearing that holds the chain at its ends is preferably configured as a sliding bearing. It can include a bearing pin and a housing element, between which a sliding bearing sleeve or sliding bearing bushing is disposed.

According to a preferred design of the invention, seen in the horizontal direction and in the direction perpendicular to the longitudinal axis the support sections of the support element are spaced from one another such that the roller elements have a defined horizontal clearance with their radial outer regions to the support sections, preferably a horizontal clearance between 1 mm and 20 mm. The shaft element is thus guided in the radial direction in a defined manner.

In plan view the support sections of the support element can further have, at least sectionally, a U-shaped design. Seen in the horizontal direction and in the direction of the longitudinal axis of the shaft part, the arms of the U-shaped-designed support sections can then be spaced from each other such that the roller elements, including the chain element, have a defined horizontal clearance to the arms, preferably a horizontal clearance between 1 mm and 20 mm. An axial locating bearing function can hereby be accomplished since at this position the shaft element can no longer shift arbitrarily in the axial direction.

The shaft section of the shaft part can be formed by a disc-shaped component, wherein an attachment flange is respectively fixed, preferably screwed, on the disc-shaped component at its two end sides, which attachment flange is connected, preferably welded, to the shaft part of each component. Two mutually axially adjacent solar panels can be connected to each other in this manner.

The invention also relates to a parabolic-trough solar power plant, comprising at least one solar panel including a shaft part, wherein the shaft part is supported using at least one bearing assembly of the explained type.

The invention is thus based on a rotatable or pivotable supporting, in particular of the solar panels of a parabolic-trough solar power plant, which makes possible a nearly restoring-force-free compensation of thermally induced expansions or shrinkages.

The central idea here is the use of support chains including integrated support rollers in which the to-be-supported structure or the shaft element is suspended.

Thermal-expansion-related displacements can thus be compensated by simple (counter-) swinging of the chain, wherein the chain ends are rotatably connected to the support pylons, i.e. to the support sections.

Exemplary embodiments of the invention are depicted in the drawings:

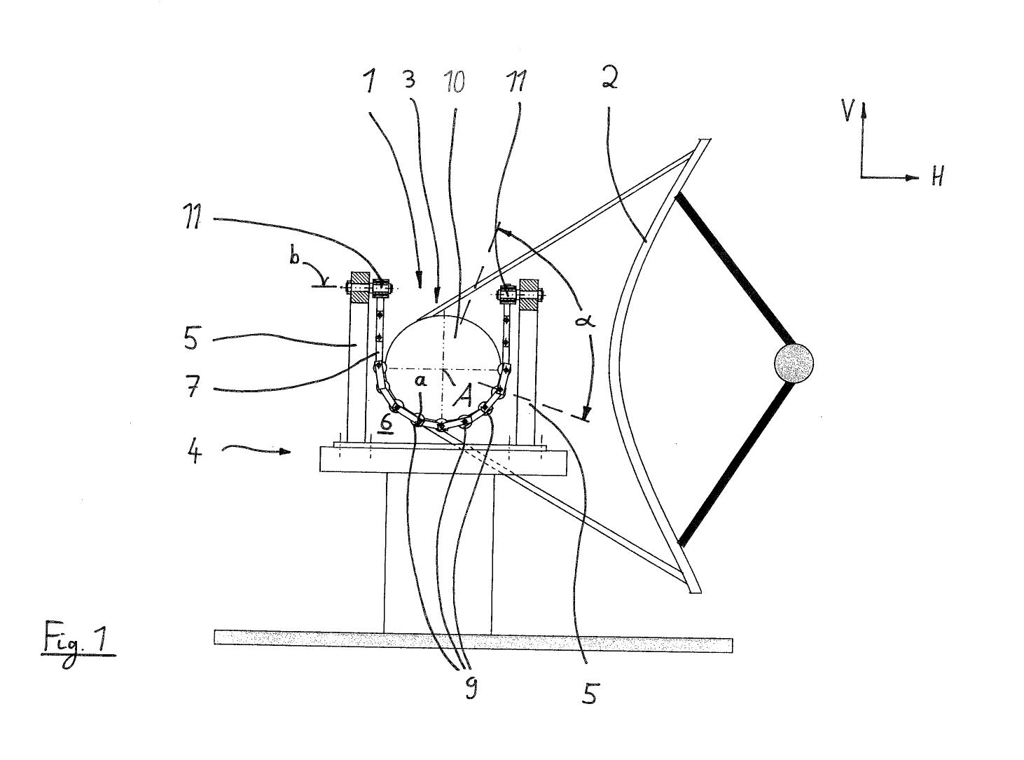

FIG. 1 shows, in side view, the solar panel of a parabolic-trough solar power plant, which is pivotably supported in a bearing assembly,

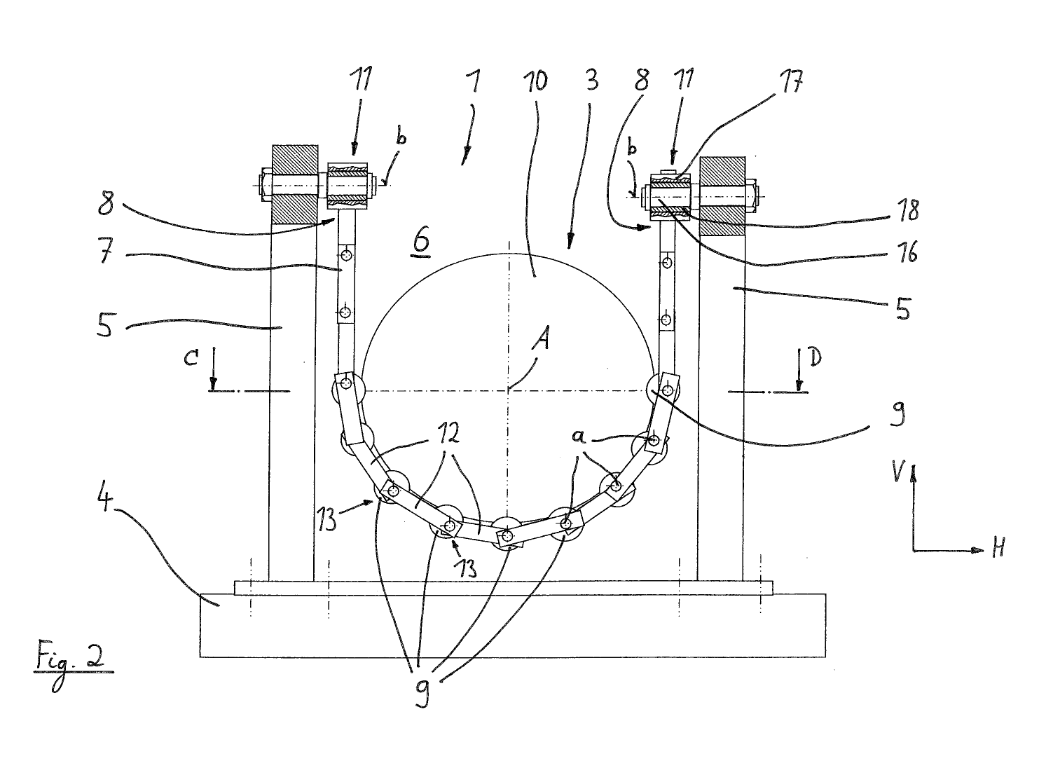

FIG. 2 shows, in side view, the bearing assembly according to FIG. 1 in enlarged depiction,

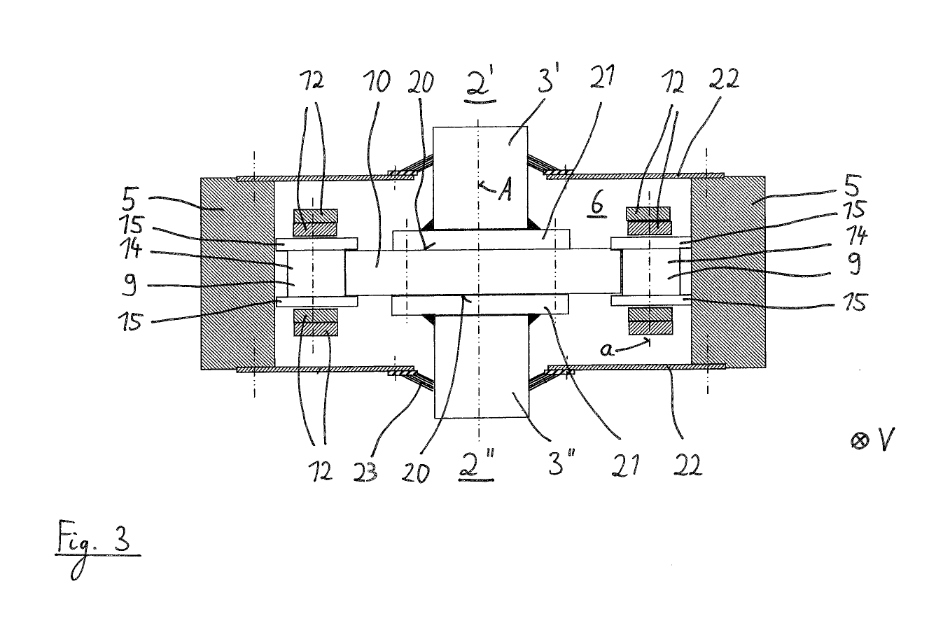

FIG. 3 shows the section C-D according to FIG. 2 according to a first embodiment of the invention,

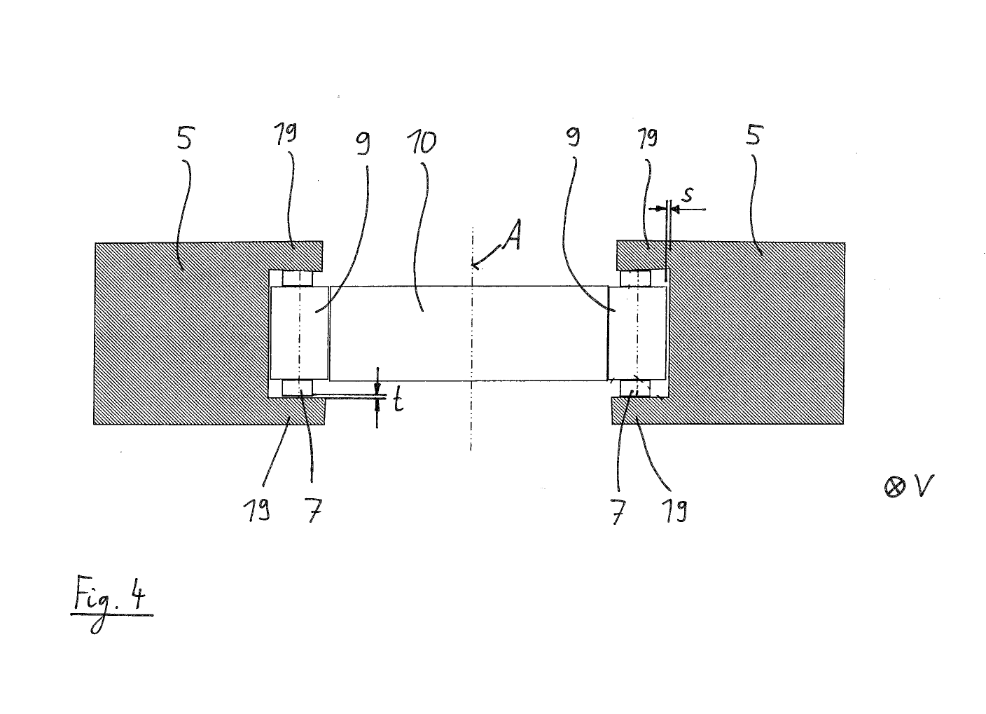

FIG. 4. shows the section C-D according to FIG. 2 according to a second embodiment of the invention,

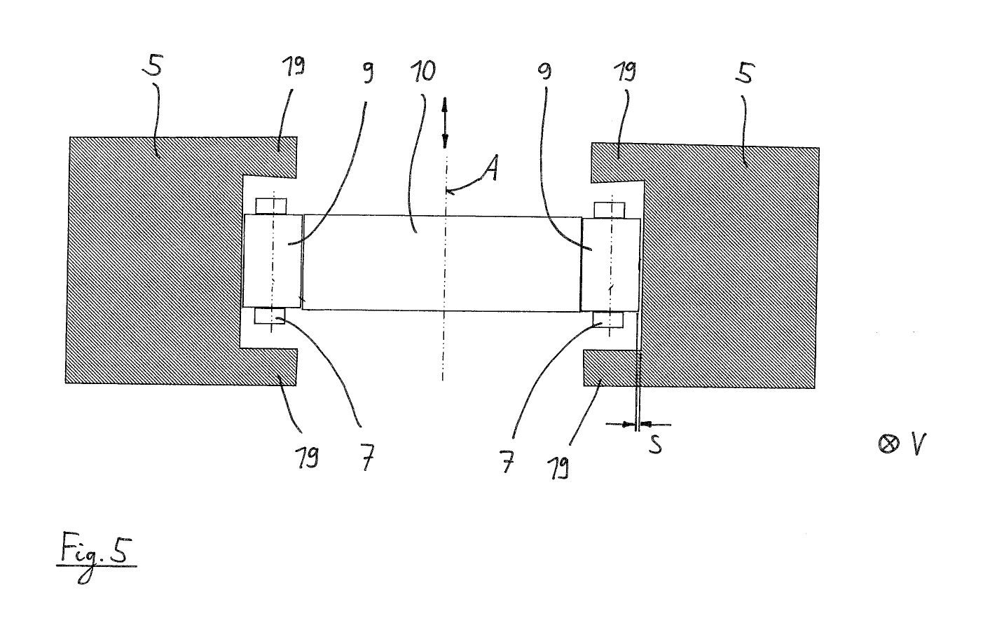

FIG. 5 shows the section C-D according to FIG. 2 according to a third embodiment of the invention, and

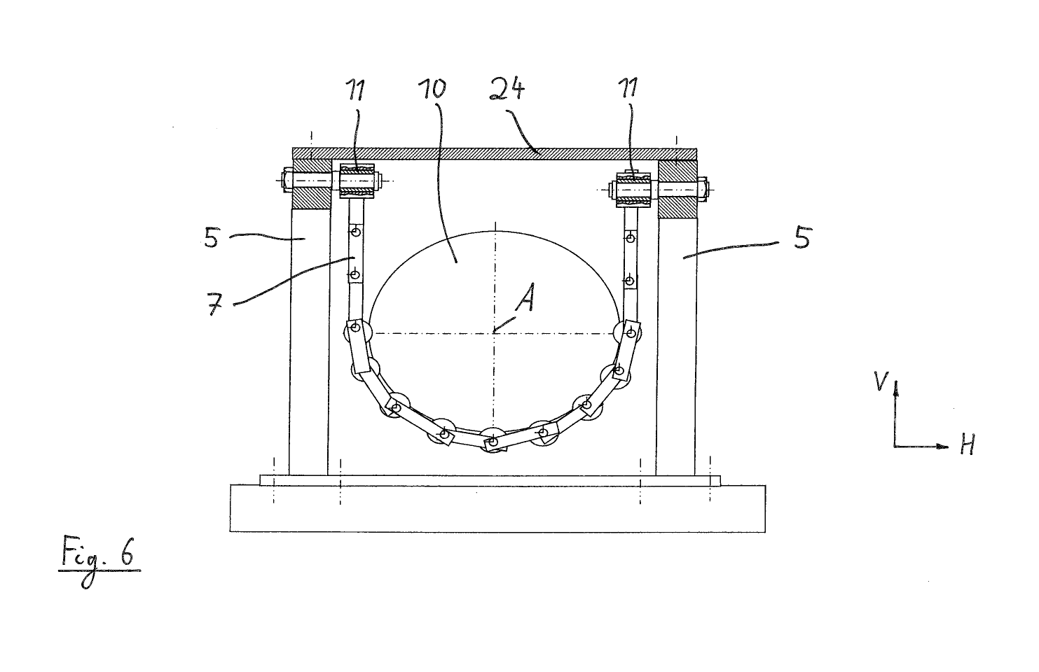

FIG. 6 shows, in the depiction according to FIG. 2, a slightly modified embodiment of the invention.

In FIG. 1 a solar panel of a parabolic-trough solar power plant is visible, which is pivotably supported in a bearing assembly 1. Accordingly the solar panel represents a component 2 that comprises a shaft part 3, which is rotatably or pivotably supported about its longitudinal axis A. The required pivot angle range is indicated by a; here this angle is approximately 90°. However, in practice this angle is typically somewhat more than 180°.

The pivoting of the component 2 about the longitudinal axis A is required in order to be able to track the solar panel to the position of the sun.

In order to make this possible in a simple manner and to be able to connect a quantity of solar panels in series in the direction of the longitudinal axis L without having to fear tension problems with temperature changes, the bearing assembly 1 firstly includes support elements 4, wherein such a support element 4 is disposed on each axial end of the component 2. The support element 4 has two pylon-type support sections 5, which extend in the vertical direction V. Due to their spacing in the horizontal direction H the two support sections 5 form a receiving space 6 between them for the shaft part 3.

The supporting of the shaft part 3, and thus of the component 2, is effected by a chain element 7, which—as can be best seen in FIG. 2—includes a quantity of chain links 12, which are connected to each other in an articulated manner at hinge points 13. At some of the hinge points 13 an axis (not shown in more detail) is located, which supports a rolling element 9; the rolling element 9 is thus rotatably supported about the axis of rotation a in the chain element 7. The axis of rotation a is parallel to the longitudinal axis A. Specifically a shaft section 10 of the shaft part 3 is supported using said roller elements 9.

The ends 8 of the chain element 7 are attached in the upper end region of the support sections 5. This attaching is effected using a bearing 7, which in the present case is configured as a sliding bearing. It has—for this purpose see FIG. 2—a bearing pin 16, which is fixedly attached (in the exemplary embodiment using a screw connection) to the support section 5. Then the bearing 11 includes a housing element 17, which is fixedly connected (for example using a weld connection) to the chain. A sliding bearing sleeve 18 is disposed between the bearing pin 16 and the housing element 17. The arrangement and orientation is designed such that a pivoting of the end of the chain element 7 about a compensation axis b can be effected, wherein this axis is oriented horizontal and in projection is perpendicular to the longitudinal axis A.

Using this arrangement it can be achieved in a simple manner that with a thermally induced displacement of the shaft part 3 at the position of the bearing assembly a compensation can be effected by a slight swaying movement of the chain element 7 about the compensation axis b.

It is illustrated in FIG. 3 how the structure is specifically designed if two solar panels, i.e. two components 2′ and 2″, are to be connected to each other in their axial end regions and to be supported using the bearing assemblies 1.

The components 2′ and 2″ include respective shaft parts 3′ and 3″, which are provided axial-end-side with an attachment flange 21. The two attachment flanges 21 are screwed onto the two end sides 20 of the shaft section 10, which is supported using the bearing assembly.

So that the shaft section 10 can be guided in a defined manner in the axial direction by the roller elements 9, the roller elements 9 have a central section 14 which has a shaping congruent to an outer circumference for the shaft section 10; in the exemplary embodiment the shaft section has a cylindrical circumferential surface; accordingly the outer circumference of the central section 14 is formed cylindrical. The central section 14 is axially flanked on each side by a flange section 15, which has an enlarged diameter (see FIG. 3). As can be immediately seen, upon inserting of the shaft section 10 into the bearing assembly 1, the same is axially guided by the flange sections 15.

Cover elements 22 are disposed end-side on the support sections 5 so that the assembly is protected from dirt; the receiving space 6 is thus laterally closed. The ingress of dirt is further impeded by brush elements 23, which abut on the shaft parts 3′, 3″.

A further aspect is whether a bearing assembly 1 of the described type functions as (axial) non-locating bearing or locating bearing. In general a single locating bearing is provided, which is centrally disposed in the connected-in-series components (solar panels) 2; the bearing assemblies connecting thereto are in general configured as non-locating bearings in order to be able to achieve said thermally induced axial compensation.

In FIG. 4 it can be seen how the locating bearing function can be realized. Here the support section is configured U-shaped, i.e. the support sections 5 have lateral arms 19.

As can be seen in the sectional view according to FIG. 4, it is provided here that a movement possibility results radially for the shaft section 10 only inside a defined horizontal clearance s, which results from the selection of the spacing of the two support sections 5. This clearance can be a few millimeters. Thus the shaft section 10, and with it also the shaft 3 and the component 2, is guided in the horizontal direction transverse to the longitudinal axis A relatively precisely and without relevant movement possibility.

This also applies in the exemplary embodiment with a view to the movement possibility in the direction of the longitudinal axis A. As can namely be seen, for the roller element 9 together with the chain element 7, due to the arms 19 a movement possibility is only present in the context of a horizontal clearance t, which can likewise be a few millimeters.

The bearing assembly 1 depicted in FIG. 4 thus functions as a locating bearing.

This is not the case with a view to the design according to FIG. 5: namely due to the horizontal clearance s a guiding in this respect is also provided outward in the radial direction.

However, the roller element 9 together with chain element 7 and (with the design of the roller elements 9 according to FIG. 3) also the shaft section 10 and thus the component 2 can shift in the direction of the longitudinal axis A, which is indicated by the double arrow in FIG. 5. The legs 19 are spaced such that a significant axial movement can occur here.

In addition, it is illustrated in FIG. 6 that the bearing element 1 can also be closed above by a cover element 24, so that a substantially sealed bearing unit arises, which is protected from environmental influences.

It is not depicted in more detail that means can be provided, using which the rotating or pivoting of the component 2 or of the components 2′, 2″, . . . can be blocked. A corresponding actuating- or clamping element can be provided for this purpose. It is thus possible to prevent the movement of the components as a result of wind.

### REFERENCE NUMBER LIST

1 Bearing assembly

2 Component

2′ Component

2″ Component

3 Shaft part

3′ Shaft part

3″ Shaft part

4 Support element

5 Support section

6 Receiving space

7 Chain element

8 End of the chain element

9 Roller element

10 Shaft section

11 Bearing (sliding bearing)

12 Chain link

13 Hinge point

14 Central section

15 Flange section

16 Bearing pin

17 Housing element

18 Sliding bearing sleeve

19 Arm

20 End side

21 Attachment flange

22 Cover element

23 Brush element

24 Cover element

A Longitudinal axis

a Axis of rotation

b Compensation axis

V Vertical direction

H Horizontal direction

a Pivot angle range

s Horizontal clearance

t Horizontal clearance

1. A parabolic-trough solar power plant comprising at least one solar panel having a shaft part having a longitudinal axis, the shaft part being supported by at least one bearing assembly, wherein the bearing assembly is configured to pivot the solar panel through a pivot angle range about the longitudinal axis wherein the bearing assembly comprises:
a support element, which includes two vertically extending support sections, wherein a receiving space for receiving the shaft part is formed between the two support sections,
a chain element that is supported with its two ends in the upper end region of the support section,
a plurality of roller elements, which are supported in the chain element along its longitudinal extension, wherein the roller elements are supported in the chain element about an axis of rotation parallel to the longitudinal axis, and wherein the roller elements are configured to support a circumferential section of a shaft section of the shaft part,
wherein the upper ends of the chain element are each attached to the support section by a bearing, and the bearing makes possible a pivoting of the chain element relative to the support section about a compensation axis (b), wherein the compensation axis (b) is disposed horizontal and in projection is perpendicular to the longitudinal axis of the shaft part, and
wherein the chain element includes a plurality of chain links, and wherein the roller elements are disposed at hinge points between pairs of the chain links.

2. (canceled)

3. The parabolic-trough solar power plant according to claim 1, wherein the roller elements have a centrally disposed central section, which is configured for making contact with the shaft section of the shaft part, and wherein the centrally disposed central section is axially delimited on both sides by two enlarged-in-diameter flange sections.

4. The parabolic-trough solar power plant according to claim 1, wherein the bearing is configured as comprises a sliding bearing.

5. The parabolic-trough solar power plant according to claim 1, wherein the bearing includes a bearing pin and a housing element, between which a sliding bearing sleeve is disposed.

6. The parabolic-trough solar power plant according to claim 1, wherein, viewed in the horizontal direction (H) and in the direction perpendicular to the longitudinal axis, the support sections of the support element are spaced from one another such that the roller elements have a defined horizontal clearance with their radial outer regions to the support sections of between 1 mm and 20 mm.

7. The parabolic-trough solar power plant according to claim 1, wherein the support sections of the support element, in plan view, have at least sectionally a U-shaped design.

8. The parabolic-trough solar power plant according to claim 1, wherein, viewed in the horizontal direction (H) and in the direction of the longitudinal axis of the shaft part, the arms of the U-shaped-designed support sections are spaced from each other such that the roller elements, together with the chain element, have a defined horizontal clearance to the arms of between 1 mm and 20 mm.

9. The parabolic-trough solar power plant according to claim 1, wherein the shaft section of the shaft part is formed by a disc-shaped component, wherein an attachment flange is respectively fixed, preferably screwed, on the disc-shaped component at its two end sides, which attachment flange is connected, to the shaft part of each component.

10. (canceled)

11. The parabolic-trough solar power plant according to claim 1,
wherein the roller elements have a centrally disposed central section configured to contact the shaft section of the shaft part, and wherein the centrally disposed central section is axially delimited on both sides by two enlarged-in-diameter flange section,
wherein the bearing comprises a sliding bearing,
wherein the bearing includes a bearing pin and a housing element and a sliding bearing sleeve disposed between the bearing pin and the housing element,
wherein, viewed in a horizontal direction and in a direction perpendicular to the longitudinal axis, the support sections of the support element are spaced from one another such that the roller elements have a defined horizontal clearance with their radial outer regions to the support sections of between 1 mm and 20 mm,
wherein the support sections of the support element, in plan view, have at least sectionally a U-shaped design,
wherein, viewed in the horizontal direction and in the direction of the longitudinal axis of the shaft part, the arms of the U-shaped-designed support sections are spaced from each other such that the roller elements, together with the chain element, have a defined horizontal clearance to the arms of between 1 mm and 20 mm, and
wherein the shaft section of the shaft part is formed by a disc-shaped component, wherein an attachment flange is respectively fixed on the disc-shaped component at its two end sides, which attachment flange is connected to the shaft part of each component.

12. A parabolic-trough solar power plant comprising:
at least one solar panel having a shaft part having a longitudinal axis, and
at least one bearing assembly supporting the at least one shaft part, the bearing assembly being configured to allow the solar panel to pivot through a pivot angle about the longitudinal axis, wherein the bearing assembly comprises:
a support element including first and second support sections defining a receiving space therebetween for receiving the shaft part,
a chain having a first end supported by a first bearing connected to the first support section, a second end supported by a second bearing connected to the second support section, a plurality of links, and a bight, and
a plurality of roller elements supported by the links of the chain for rotation about an axis of rotation parallel to the longitudinal axis, the roller elements being configured to support a circumferential section of a shaft section of the shaft part,
wherein the first bearing and second bearing are configured to permit a pivoting of the chain element relative to the first and second support sections about a compensation axis perpendicular to the longitudinal axis of the shaft part.

13. The parabolic-trough solar power plant according to claim 12, wherein pairs of the plurality of links are connected at hinge points and wherein the roller elements are supported at the hinge points.
